(19) United States
(12) Patent Application Publication
(10) Pub. No.: US 2022/0166061 A1
(43) Pub. Date: May 26, 2022

(54) ELECTRODE FOR LITHIUM-ION SECONDARY BATTERY, AND LITHIUM-ION SECONDARY BATTERY

(71) Applicant: HONDA MOTOR CO., LTD., Tokyo (JP)

(72) Inventors: Takeshi FUJINO, Saitama (JP); Kazuki SAIMEN, Saitama (JP); Kazuaki MATSUMOTO, Saitama (JP)

(21) Appl. No.: 17/598,904

(22) PCT Filed: Mar. 29, 2019
(86) PCT No.: PCT/JP2019/014003

§ 371 Date: Sep. 28, 2021

(51) Int. Cl. H01M 10/0562; H01M 10/0525

(52) U.S. Cl. CPC H01M 10/0562; H01M 2300/0077; H01M 10/0525

(57) ABSTRACT

Provided are an electrode for a lithium-ion secondary battery enabling the realization of a battery that has a high volume energy density and exhibits a low level of degradation in output due to repeated charging and discharging even in a case in which the amount of an electrolyte solution held by the electrode is low, and a lithium-ion secondary battery including the positive electrode.

The coexistence of a high dielectric oxide solid and a highly concentrated electrolyte solution in a gap between articles of an active material inside the electrode is achieved.

### TECHNICAL FIELD

The present invention relates to an electrode for a lithium-ion secondary battery, and a lithium-ion secondary battery including the electrode.

### BACKGROUND ART

Conventionally, lithium-ion secondary batteries are widely used as secondary batteries with high energy density.

A lithium-ion secondary battery which employs a liquid as an electrolyte has a structure in which a separator is disposed between a positive electrode and a negative electrode, and the space between the positive electrode and the negative electrode is filled with a liquid electrolyte (electrolyte solution).

Since the electrolyte solution of the lithium-ion secondary battery is usually a flammable organic solvent, the safety to heat, in particular, becomes a problem in some cases.

Therefore, a solid-state battery employing a flame-retardant, solid electrolyte instead of the organic liquid electrolyte has also been proposed.

Such lithium-ion secondary batteries should satisfy various requirements depending on their applications.

For example, when the application to motor vehicles and the like is intended, a battery is desired which has high energy density and exhibits little degradation in output characteristics after repeated charging and discharging.

However, the output characteristics of the lithium-ion secondary batteries generally tend to be degraded after the repeated charging and discharging.

This is because the electrolyte solution decomposes during the repeated charging and discharging, to form a passive film on the electrodes, which gradually increases the internal resistance.

To address this problem, a method has been proposed in which W is used in addition to at least one metal element of Ni, Co and Mn as a positive electrode active material, and at least one of a difluorophosphate salt and a monofluorophosphate salt is added to an electrolyte solution (see Patent Document 1).

In addition, a method has also been proposed in which W is used in addition to at least one metal element of Ni, Co and Mn as a positive electrode active material, and a difluorobisoxalatophosphate salt is added to an electrolyte solution (see Patent Document 2).

According to the technologies described in Patent Documents 1 and 2, excellent output characteristics can be maintained within an operating temperature range from low temperature such as about 0° C. to elevated temperature such as about 60° C.

On the other hand, solutions for a demand to further increase volume energy density of lithium-ion secondary batteries, which is one of required characteristics for lithium-ion secondary batteries, include a method in which the packing density of an electrode active material is increased.

However, the increase in the packing density of the electrode active material decreases a gap between particles of the active material inside an electrode, leading to relative reduction of the amount of the electrolyte solution held by the electrode.

Further, an electrode having a large packing density of an electrode active material tends to have a higher electrode surface pressure due to e.g. the expansion of a negative electrode active material during charging and discharging, and thus to cause the pushing-out of the electrolyte solution present between the electrode active materials and the resultant depletion of the electrolyte solution.

Moreover, if the amount of electrolyte held by the electrode is insufficient or unevenly distributed, and charging and discharging are repeated, resistance increases due to the lack of lithium ions, causing potential variation, and as a result, the solvent that makes up the electrolyte solution is more likely to decompose, and a passive film is more likely to form on the electrode.

Under the circumstances described above, a lithium-ion secondary battery that exhibits little degradation in output after repeated charging and discharging, even in a case in which the amount of the electrolyte solution held by the electrode is low, has not been sufficiently realized.
Patent Document 1: Japanese Unexamined Patent Application, Publication No. 2013-069580
Patent Document 2: Japanese Unexamined Patent Application, Publication No. 2014-183031

### DISCLOSURE OF THE INVENTION

### Problems to be Solved by the Invention

The present invention was made in view of the foregoing, and an object of the present invention is to provide an electrode for a lithium-ion secondary battery enabling the realization of a battery that has a high volume energy density and exhibits suppression of the degradation in output due to repeated charging and discharging even in a case in which the amount of the electrolyte solution held by the electrode is low, and a lithium-ion secondary battery including the positive electrode.

### Means for Solving the Problems

The present inventors considered that the coexistence of not only the electrolyte solution but also high dielectric solid particles would prevent the uneven distribution of the electrolyte solution in the electrode and concurrently improve ionic conductivity, leading to the suppression of an increase in resistance inside the battery during repeated charging and discharging, and conducted extensive studies. As a result, the present inventors found that the distribution of a high dielectric oxide and a highly concentrated electrolyte solution into a gap between particles of the active material inside the electrode could solve the problems described above, to accomplish the present invention.

More specifically, an aspect of the present invention relates to an electrode for a lithium-ion secondary battery including an electrode active material, a high dielectric oxide solid, and an electrolyte solution, wherein the high dielectric oxide solid and the electrolyte solution are located in a gap formed between particles of the electrode active material, and wherein the concentration of a lithium salt in the electrolyte solution is 0.5 to 3.0 mol/L.

The electrode for a lithium-ion secondary battery according to claim 1, wherein in the cross-section observation of the electrode for a lithium-ion secondary battery, the proportion of the cross-sectional area of the high dielectric oxide solid with respect to the cross-sectional area of the entire gap is 1 to 22%.

The high dielectric oxide solid may be a solid oxide electrolyte.

The solid oxide electrolyte may be at least one selected from the group consisting of Li₇La₃Zr₂O₁₂ (LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7}(PO₄)₃ (LATP), and L_{1.6}Al_{0.6}Ge_{1.4}(PO₄)₃ (LAGP).

The volume filling factor of the electrode active material may be 60% or more with respect to the total volume of the electrode composite material constituting the electrode.

The thickness of the electrode for a lithium-ion secondary battery may be 40 μm or more.

The electrode for a lithium-ion secondary battery may be a positive electrode.

The electrode for a lithium-ion secondary battery may be a negative electrode.

Moreover, another aspect of the present invention relates to a lithium-ion secondary battery including the electrode for a lithium-ion secondary battery as described above, and an electrolyte solution.

### Effects of the Invention

According to the electrode for a lithium-ion secondary battery of an aspect of the present invention, a reduction of the diffusion of lithium ions inside the electrode can be suppressed and an increase in resistance can be suppressed even in a case in which the thickness of the electrode is large and the packing density of an electrode active material is high.

As a result, a lithium-ion secondary battery can be realized which has a high volume energy density and exhibits suppression of the degradation in output due to repeated charging and discharging even in a case in which the amount of the electrolyte solution held by the electrode is low.

Normally, when the concentration of a lithium salt in the electrolyte solution is high, the viscosity of the electrolyte solution is increased, and thus the penetration of the electrolyte solution into the electrode is reduced.

However, in the electrode for a lithium-ion secondary battery of an aspect of the present invention, since not only the electrolyte solution but also the high dielectric oxide solid is present in the gap formed between the particles of the electrode active material, the penetration of the electrolyte solution is improved.

As a result, the uniformity of the retention of the electrolyte solution within the electrode is improved.

Further, the time required for impregnation of the electrode with the electrolyte solution can be reduced, leading to an improvement in productivity.

In addition, when the concentration of the lithium salt in the electrolyte solution is high, the association of the lithium ion and an anion normally occurs. Thus, in an electrolyte solution having a high concentration of the lithium salt and a resultant increased viscosity, the ionic conductivity tends to decrease.

However, in the electrode for a lithium-ion secondary battery of an aspect of the present invention, since not only the electrolyte solution but also the high dielectric oxide solid is present in the gap formed between the particles of the electrode active material, the association of the lithium ion and the anion can be inhibited due to dielectric effects.

As a result, a battery with low resistance can be obtained even when an electrolyte solution containing a high concentration of the lithium salt is employed.

### BRIEF DESCRIPTION OF THE DRAWINGS

FIG. 1 is a diagram illustrating one embodiment of a lithium-ion secondary battery of the present invention;

FIG. 2 is a graph illustrating the relationship between the lithium salt concentration and the resistance value in the lithium-ion secondary battery according to Examples 1 to 4 of the present invention;

FIG. 3 is a graph illustrating the relationship between the lithium salt concentration and the resistance value in the lithium-ion secondary battery according to Comparative Examples 1 to 4 of the present invention; and

FIG. 4 is a graph illustrating the capacity maintenance rates of the lithium-ion secondary batteries according to Examples 1 to 4 and Comparative Examples 1 to 4 of the present invention.

### PREFERRED MODE FOR CARRYING OUT THE INVENTION

Hereinafter, embodiments of the present invention will be described.

It should be noted that the present invention is not limited to the following embodiments.

### <Electrode for Lithium-Ion Secondary Battery>

An electrode for a lithium-ion secondary battery of an embodiment of the present invention includes an electrode active material, a high dielectric oxide solid, and an electrolyte solution.

The high dielectric oxide solid and the electrolyte solution are located in a gap formed between particles of the electrode active material, and the concentration of a lithium salt in the electrolyte solution is 0.5 to 3.0 mol/L.

The electrode for a lithium-ion secondary battery of the embodiment of the present invention may be a positive electrode for a lithium-ion secondary battery, or a negative electrode for a lithium-ion secondary battery.

Whether the electrode for a lithium-ion secondary battery of the present invention is the positive electrode or the negative electrode, the effects of the invention can be obtained by the application of the configuration of the present invention.

In addition, the configuration of the electrode for a lithium-ion secondary battery of the embodiment of the present invention is not particularly limited, and examples thereof include a configuration in which an electrode composite material layer formed from an electrode composite material containing an electrode active material is overlaid on an electrode current collector, and the electrode composite material layer is impregnated with an electrolyte solution.

The electrode composite material layer contains the electrode active material and the high dielectric oxide solid, which are constitutive elements of the embodiment of the present invention, as essential components, and may optionally contain known components such as a conductivity aid, a binder, and the like.

### [Current Collector]

An electrode current collector in the electrode for a lithium-ion secondary battery of the embodiment of the present invention is not particularly limited, and any known current collector for use in lithium-ion secondary batteries may be used.

Examples of the material of a positive electrode current collector may include metal materials such as SUS, Ni, Cr, Au, Pt, Al, Fe, Ti, Zn and Cu, and the like.

Examples of the material of a negative electrode current collector include SUS, Ni, Cu, Ti, Al, baked carbon, electroconductive polymers, electroconductive glass, Al—Cd alloy, and the like.

In addition, examples of the shape of the electrode current collector may include a foil-like shape, plate-like shape, mesh-like shape, and the like.

The thickness of the electrode current collector is also not particularly limited, and is, for example, 1 to 20 μm, but may be appropriately selected as needed.

### [Electrode Active Material]

An electrode active material contained in the electrode for a lithium-ion secondary battery of the embodiment of the present invention is not particularly limited so long as the electrode active material is capable of storing and releasing lithium ions, and any substance known as an electrode active material for lithium-ion secondary batteries may be applied.

### (Positive Electrode Active Material)

In the case where the electrode for a lithium-ion secondary battery of the embodiment of the present invention is a positive electrode for a lithium-ion secondary battery, a positive electrode active material layer is exemplified by LiCoO₂, LiCoO₄, LiMnxO₄, LiNiO₂, LiFePO₄, lithium sulfide, sulfur, and the like.

The positive electrode active material may be selected from materials that are capable of constituting an electrode and exhibit a higher potential as compared with a negative electrode.

In the case where the electrode for a lithium-ion secondary battery of the embodiment of the present invention is a negative electrode for a lithium-ion secondary battery, a negative electrode active material is exemplified by metallic lithium, lithium alloys, metal oxides, metal sulfides, metal nitrides, silicon oxide, silicon, and carbon materials such as graphite, and the like.

The negative electrode active material may be selected from materials that are capable of constituting an electrode and exhibit a lower potential as compared with the positive electrode.

### (Electrode Composite Material Layer)

In the electrode for a lithium-ion secondary battery of the embodiment of the present invention, an electrode composite material layer, which contains the electrode active material as an essential component, should be formed on at least one side of the current collector, or may be formed on both sides of the current collector. The electrode composite material layer may be appropriately selected depending on the type and structure of the intended lithium-ion secondary battery.

In addition, the electrode composite material layer contains, as essential components, the electrode active material and the high dielectric oxide solid, which are the constitutive elements of the embodiment of the present invention, and may be contain any known components such as a conductivity aid and a binder, as arbitrary components.

The addition of the high dielectric oxide solid to be located in a gap between the particles of the electrode active material to the electrode composite material allows for easy placement of the high dielectric oxide solid between the particles of the electrode active material in the formed electrode composite material layer.

Incidentally, the preparation of a paste to be used as the electrode composite material by attaching the high dielectric oxide solid to the conductivity aid, the binder, or the like beforehand, followed by mixing with the electrode active material enables the dielectric solid powder to be located more uniformly in the gap between the particles of the electrode active material.

### [Volume Filling Factor of Electrode Active Material]

The volume filling factor of the electrode active material in the electrode for a lithium-ion secondary battery of the embodiment of the present invention is preferably 60% or more with respect to the total volume of the electrode composite material constituting the electrode. When the volume filling factor of the electrode active material is 60% or more, the proportion of the gap formed between the particles of the electrode active material is less than 40%.

Therefore, an electrode for a lithium-ion secondary battery which has a small proportion of the gap is obtained, which means that an electrode having a high volume energy density can be obtained.

When the volume filling factor of the electrode active material is 60% or more, a cell can achieve a high volume energy density of 500 Wh/L or more, for example.

Incidentally, in the present invention, the volume filling factor of the electrode active material with respect to the total volume of the electrode composite material constituting the electrode is more preferably 65% or more, and most preferably 70% or more.

### (Gap)

The electrode for a lithium-ion secondary battery of the embodiment of the present invention has a gap between the particles of the electrode active material.

The gap formed between the particles of the electrode active material can be controlled by the filling factor of the electrode active material, and relates to the density of the electrode composite material layer.

The present invention is characterized in that the high dielectric oxide solid and the electrolyte solution are located in this gap between the particles of the electrode active material.

In addition, a resin binder serving as a binder, a carbon material for providing electron conductivity, and the like may be located in the gap.

In the electrode for a lithium-ion secondary battery of the embodiment of the present invention, the placement of the high dielectric oxide solid and the electrolyte solution in the gap between the particles of the electrode active material makes it possible to suppress a reduction of the diffusion of lithium ions inside the electrode and thereby suppress an increase in resistance, and to achieve an electrode having a high packing density of the electrode active material.

As a result, a lithium-ion secondary battery can be realized which has a high volume energy density and exhibits suppression of a reduction in output due to repeated charging and discharging even in a case in which the amount of the electrolyte solution held by the electrode is low.

In addition, in the electrode for a lithium-ion secondary battery of the embodiment of the present invention, since not only the electrolyte solution but also the high dielectric oxide solid is present in the gap between the particles of the electrode active material, the penetration of the electrolyte solution is improved.

As a result, the uniformity of the retention of the electrolyte solution within the electrode is improved.

In addition, the time required for impregnation of the electrode with the electrolyte solution can be reduced, leading to an improvement in productivity.

Furthermore, in the electrode for a lithium-ion secondary battery of the embodiment of the present invention, since not only the electrolyte solution but also the high dielectric oxide solid is present in the gap between the particles of the electrode active material, the association of the lithium ion and the anion can be inhibited due to dielectric effects.

As a result, the resistance can be reduced even in the case where an electrolyte solution containing a high concentration of the lithium salt is employed.

### (Cross-Sectional Area Occupancy of High Dielectric Oxide Solid in Gap)

In the electrode for a lithium-ion secondary battery of the embodiment of the present invention, regarding the occupancy of the high dielectric oxide solid in the gap between the particles of the electrode active material, the proportion of the cross-sectional area of the high dielectric oxide solid with respect to the cross-sectional area of the entire gap is preferably in the range of 1 to 22% in the cross-section observation of the electrode for a lithium-ion secondary battery.

With this range, both low resistance and improved durability can be achieved.

Here, the gap in the context of the present invention refers to a region other than that occupied by the active material in the electrode composite material layer, as described above, and a resin binder serving as a binder, a carbon material for providing electron conductivity, and the like may be located in the gap.

In determining the occupancy of the high dielectric oxide solid in the gap, the cross-section observation of the electrode for a lithium-ion secondary battery is carried out.

The cross-section observation may be carried out according to the following procedure.

### (Procedure of Cross-Section Observation)

A cross-section of the electrode composite material layer is prepared by ion milling, and observed via SEM.
The imaging area of the cross-section on which SEM is to be performed is selected such that about 80% or more of the electrode composite material layer in the direction of the thickness of the electrode (vertical direction) is observed.
The magnification of the image is set to about 5,000× to 10,000×, and the image is divided and captured as multiple images.
An image in the surface direction (left-right direction) is also captured similarly to the operation for the vertical direction.
The obtained images are combined and binarized for the brightness of the reflected electron image, and the area occupancy of each component that makes up the electrode composite material is derived from the brightness distribution curve.
Regarding the area occupancy, the active material area and the oxide solid area are determined, and the dark area other than the active material area and the oxide solid area is defined as a remaining space. The remaining space includes the resin binder, the conductivity aid, and the like, and additionally vacancies into which the electrolyte solution penetrates.

The reasons for the preferable range of the cross-sectional area occupancy of the high dielectric oxide solid in the gap as described above are related to the dielectric constant of the high dielectric oxide solid itself.

Specifically, the higher the dielectric constant of the high dielectric oxide solid is, the greater the effects on the electrolyte solution are. Thus, the preferred cross-sectional area occupancy of the high dielectric oxide solid approaches 1%.

Conversely, when the dielectric constant of the high dielectric oxide solid is low, the preferred cross-sectional area occupancy of the high dielectric oxide solid approaches 22%.

When the cross-sectional area occupancy of the high dielectric oxide solid is less than 1%, the dielectric effect of the high dielectric oxide solid is reduced, and merely the same effect as that of a normal electrolyte solution is achieved.

On the other hand, when the cross-sectional area occupancy of the high dielectric oxide solid is greater than 22%, the amount of the electrolyte solution is relatively reduced in the gap and a lack of the liquid is caused, leading to decreased migration pathways of the lithium ions and increased internal resistance, which makes achievement of the effects of the low resistance difficult.

### [High Dielectric Oxide Solid]

In the electrode for a lithium-ion secondary battery of the embodiment of the present invention, the high dielectric oxide solid, which is located in the gap between the particles of the electrode active material, is not particularly limited so long as it is an oxide with high dielectricity, and is preferably a solid oxide electrolyte. The solid oxide electrolyte makes it possible to produce an inexpensive crystal, and exhibits excellent resistance to electrochemical oxidation and, and excellent resistance to reduction. In particular, Li-based oxides are preferred, since they have a low true specific gravity and are unlikely to increase the cell weight upon the addition thereof to the electrode.

Examples of the solid oxide electrolyte include Li₇La₃Zr₂O₁₂ (LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7} (PO₄) (LATP), and Li_{1.6}Al_{0.6}Ge_{1.4}(PO₄)₃ (LAGP), and in the embodiment of the present invention, the application of at least one selected from the group consisting of the above-listed solid oxide electrolytes is preferable.

### (Particle Size)

The suitable particle size of the high dielectric oxide solid is not particularly limited, and is preferably 0.1 Lim or more and about 10 μm or less, which is less than or equal to the particle size of the active material.

When the particle size of the high dielectric oxide solid is too small, the high dielectric oxide solid tends to adhere to the surface of the electrode active material, and interfere with the electron conductivity, resulting in high cell resistance.

Further, the oxide particulates have lower anisotropy of the crystal structure and a lower dielectric constant, and therefore the effects of the present invention are less likely to be sufficiently achieved.

On the other hand, when the particle size is too large, the high dielectric oxide solid is not located in the gap, which inhibits an improvement of the filling factor of the active material to electrode body.

### [Electrolyte Solution]

In the electrode for a lithium-ion secondary battery of the embodiment of the present invention, the electrolyte solution to be located in the gap between the particles of the electrode active material is not particularly limited, and any electrolyte solution known as an electrolyte solution for lithium-ion secondary batteries may be applied.

It should be noted that an electrolyte solution used in the formation of a secondary battery using the electrode for a lithium-ion secondary battery of the embodiment of the present invention may be identical to or different from an electrolyte solution to be located in the electrode for a lithium-ion secondary battery of the embodiment of the present invention.

### (Solvent)

A solvent used in the electrolyte solution may be any solvent that forms a general nonaqueous electrolyte.

The solvent is exemplified by a solvent with a cyclic structure such as ethylene carbonate (EC) and propylene carbonate (PC), a solvent consisting of a chain structure such as dimethyl carbonate (DMC), ethyl methyl carbonate (EC) and diethyl carbonate (DEC).

In addition, partially fluorinated solvents such as fluoroethylene carbonate (FEC) and difluoroethylene carbonate (DFEC) can be used.

In addition, known additives may be added to the electrolyte solution, and examples of the additives include vinylene carbonate (VC), vinyl ethylene carbonate (VEC), propane sultone (PS), fluoroethylene carbonate (FEC), and the like.

Moreover, an ionic liquid may be contained as the electrolyte solution.

Examples of the ionic liquid include pyrrolidinium, piperidinium, imidazolium, and the like, which include a quaternary ammonium cation.

In the embodiment of the present invention, it is desirable to use a solvent with a high dielectric constant such as EC and PC in combination with a solvent with low viscosity such as DMC and EMC. The use of the solvent with a high dielectric constant provides an improvement of the degree of dissociation of the lithium salt, and enables the lithium salt to be used in high concentration.

In addition, since the use of the solvent with a high dielectric constant alone results in high viscosity and low ionic conductivity, the adjustment of the viscosity through adequate addition of the solvent with low viscosity is necessary.

As for the composition of the electrolyte solution, it is preferable that the amount of the solvent with a high dielectric constant such as EC and PC is 20% by volume or more and 40% by volume or less.

The amount of the solvent with a high dielectric constant is more desirably 25% by volume or more and 35% by volume or less.

### (Lithium Salt)

In the electrode for a lithium-ion secondary battery of the embodiment of the present invention, the lithium salt contained in the electrolyte solution to be located in the gap between the particles of the electrode active material is not particularly limited, and examples thereof include LiPF₆, LiBF₄, LiClO₄, LiN(SO₂CF₃), LiN(SO₂F₅)₂, LiCF₃SO₃, and the like.

Of these, LiPF₆ and LiBF₄, which have high ionic conductivity and a high degree of dissociation, or a mixture thereof is preferable.

It should be noted that the concentration of the lithium salt to be contained in the electrolyte solution to be located in the gap between the particles of the electrode active material is in the range of 0.5 to 3.0 mol/L.

When the concentration is less than 0.5 mol/L, the ionic conductivity is lowered, whereas the concentration is more than 3.0 mol/L, the viscosity is increased and the ionic conductivity is lowered, and the effects of the solid oxide are unlikely to sufficiently obtained.

It should be noted that in the present invention, the concentration of the lithium salt to be contained in the electrolyte solution to be located in the gap between the particles of the electrode active material is preferably in the range of 1.0 to 3.0 mol/L, and most preferably is in the range of 1.2 to 2.2 mol/L for enhancing the output performance after a durability test.

Typically, when the concentration of a lithium salt in the electrolyte solution is high, the viscosity of the electrolyte solution is increased, and hence the penetration of the electrolyte solution into the electrode is reduced.

However, in the electrode for a lithium-ion secondary battery of the embodiment of the present invention, the penetration of the electrolyte solution is improved since not only the electrolyte solution but also the high dielectric oxide solid is present in the gap formed between the particles of the electrode active material.

In addition, when the concentration of a lithium salt in the electrolyte solution is high, the association of the lithium ion and an anion normally occurs. Thus, the ionic conductivity tends to decrease.

However, as for the electrode for a lithium-ion secondary battery of the embodiment of the present invention, it is presumed that since not only the electrolyte solution but also the high dielectric oxide solid is present in the gap formed between the particles of the electrode active material, the ionic conductivity is improved.

Thus, in the electrode for a lithium-ion secondary battery of the embodiment of the present invention, an electrolyte solution having higher concentration of lithium salts than the concentration of the lithium salts in electrolyte solutions applied to typical lithium-ion secondary batteries can be applied to the electrolyte solution to be located in the gap between the particles of the electrode active material.

Even when an electrolyte solution with higher concentration is applied, the productivity can be improved because of the short period of time required for impregnation of the electrode with the electrolyte solution, and a battery with high initial capacity can be obtained.

Therefore, in the electrode for a lithium-ion secondary battery of the embodiment of the present invention, the effects of the invention can be demonstrated more clearly in the case of electrolyte solutions having a higher concentration of lithium salts added.

### (Solvent)

The solvent contained in the electrolyte solution to be located in the gap between the particles of the electrode active material is not particularly limited, and any solvent for use in an electrolyte solution of lithium-ion secondary batteries may be applied as appropriate.

Examples of the solvent include aprotic solvents such as carbonates, esters, ethers, nitriles, sulfones, lactones.

Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone and the like may be mentioned.

Incidentally, in the electrode for a lithium-ion secondary battery of the embodiment of the present invention, since not only the electrolyte solution but also the high dielectric oxide solid is present in the gap formed between the particles of the electrode active material, as described above, the association of the lithium ion and the anion is inhibited due to the dielectric effect. Therefore, it is also possible to use an electrolyte solution with low viscosity by decreasing the proportion of a cyclic carbonate such as ethylene carbonate (EC) and increasing the proportion of a chain carbonate, which has lower viscosity.

### (Thickness)

The thickness of the electrode for a lithium-ion secondary battery of the embodiment of the present invention is not particularly limited, and is preferable, for example, 40 μm or more.

When the thickness is 40 μm or more and the volume filling factor of the electrode active material is 60% or more, the resultant electrode for a lithium-ion secondary battery is a high density electrode. Further, the volume energy density of the battery cell produced can reach 500 Wh/L or more.

### <Production Method of Electrode for Lithium-Ion Secondary Battery>

A production method of the electrode for a lithium-ion secondary battery of the embodiment of the present invention is not particularly limited, and any conventional method in the art may be applied.

For example, a method may be mentioned in which an electrode paste which serves as an electrode composite material containing the electrode active material and the high dielectric oxide solid as essential components is applied to an electrode current collector, dried, and then rolled, and subsequently impregnation with the electrolyte solution is performed.

In this method, the volume filling factor of the electrode active material (i.e., the proportion of the gap formed between the particles of the electrode active material) can be controlled by changing a pressing pressure during the rolling.

Any known method may be applied as the method for applying the electrode paste to the electrode current collector.

For example, roller coating such as applicator roll, screen coating, blade coating, spin coating, bar coating and other method may be employed.

### <Lithium-Ion Secondary Battery>

A lithium-ion secondary battery of an embodiment of the present invention includes the electrode for a lithium-ion secondary battery of the embodiment of the present invention, and an electrolyte solution.

The electrode for a lithium-ion secondary battery of the embodiment of the present invention in the lithium-ion secondary battery of the embodiment of the present invention may be a positive electrode or a negative electrode, and each of the positive electrode and the negative electrode may be the electrode for a lithium-ion secondary battery of the embodiment of the present invention.

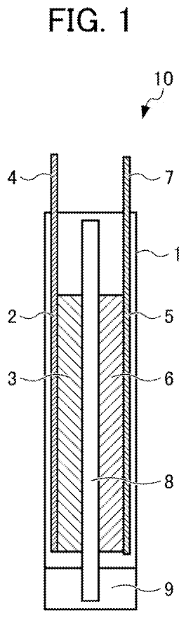

FIG. 1 shows one embodiment of the lithium-ion secondary battery of the present invention.

A lithium-ion secondary battery 10 shown in FIG. 1 includes a positive electrode 4 including a positive electrode composite material layer 3 formed on a positive electrode current collector 2, a negative electrode 7 including a negative electrode composite material layer 6 formed on a negative electrode current collector 5, a separator 8 electrically insulating the positive electrode 4 and the negative electrode 7, an electrolyte solution 9, and a container 1 accommodating the positive electrode 4, the negative electrode 7, the separator 8 and the electrolyte solution 9.

In the container 1, the positive electrode composite material layer 3 and the negative electrode composite material layer 6 face each other with the separator 8 in between, and an electrolyte solution 9 is stored below the positive electrode composite material layer 3 and the negative electrode composite material layer 6. Moreover, an end portion of the separator 8 is immersed in the electrolyte solution 9.

The positive electrode 4 or the negative electrode 7, or both, are the electrode for a lithium-ion secondary battery of the embodiment of the present invention, and contain the electrode active material, the high dielectric oxide solid, and the electrolyte solution, and the high dielectric oxide solid and the electrolyte solution are located in a gap formed between particles of the electrode active material.

### [Positive Electrode and Negative Electrode]

In the lithium-ion secondary battery of the embodiment of the present invention, the positive electrode or the negative electrode, or both of the positive electrode and the negative electrode are the electrode for a lithium-ion secondary battery of the embodiment of the present invention.

It should be noted that when only the positive electrode is the electrode for a lithium-ion secondary battery of the embodiment of the present invention, a metal, a carbon material or the like which may be employed as the negative electrode active material may be directly used as the negative electrode in the form of a sheet.

### [Electrolyte Solution]

The electrolyte solution applied to the lithium-ion secondary battery of the embodiment of the present invention is not particularly limited, and any electrolyte solution known as an electrolyte solution of lithium-ion secondary batteries may be used.

It should be noted that the electrolyte solution used in the formation of the secondary battery may be identical to or different from the electrolyte solution located in the electrode for a lithium-ion secondary battery of the embodiment of the present invention.

### <Production Method of Lithium-Ion Secondary Battery>

A production method of the lithium-ion secondary battery of the embodiment of the present invention is not particularly limited, and any conventional method in the art may be applied.

### EXAMPLES

Next, the present invention will be described in more detail based on examples, but the present invention is not limited thereto.

### Example 1

### [Preparation of Positive Electrode]

Acetylene black as a conductivity aid and Li_{1.3}Al_{0.3}Ti_{1.7}(PO₄)₃ (LATP) as a solid oxide electrolyte were mixed, and dispersed using a planetary centrifugal mixer, to obtain a mixture.

Subsequently, to the obtained mixture were added polyvinylidene fluoride (PVDF) as a binder and LiNi_{0.6}Co_{0.2}Mn_{0.2}O₂ (NCM622, D50=12 μm) as a positive electrode active material, followed by dispersion treatment using a planetary mixer, to obtain a mixture for a positive electrode composite material.

The ratio of each component in the mixture for a positive electrode composite material was adjusted to achieve the positive electrode active material:LATP:conductivity aid:resin binder (PVDF) of 92.1:2:4.1:1.8 in mass ratio, in other words, adjusted such that the amount of LATP added was 2 parts by mass with respect to 100 parts by mass of the mixture for a positive electrode composite material. Subsequently, the obtained mixture for a positive electrode composite material was dispersed in N-methyl-2-pyrrolidone (NMP), to prepare a positive electrode composite material paste.

An aluminum foil having a thickness of 12 μm was provided as a current collector, and the positive electrode composite material paste prepared above was applied to one side of the current collector, dried at 120° C. for 10 min, then compressed with a roll press at a linear pressure of 1 t/cm, and subsequently dried in vacuo at 120° C., to prepare a positive electrode for a lithium-ion secondary battery. Incidentally, the positive electrode prepared thus was punched into 30 mm×40 mm pieces and then used.

The thickness of the electrode composite material layer in the obtained positive electrode for a lithium-ion secondary battery was 68 μm.

In addition, the volume filling factor of the electrode active material with respect to the total volume of the electrode composite material was 65.9%.

The measurement methods will be described below.

### (Measurement Method for Thickness of Electrode Composite Material Layer)

In the obtained positive electrode for a lithium-ion secondary battery, the current collecting foil and the electrode composite material layer are integrated.

The entire thickness of these components was measured with a thickness gauge, and the thickness of the current collecting foil was subtracted from the measurement value, to determine the thickness of the electrode composite material layer.

(Determination Method for Volume Filling Factor of Electrode Active Material with Respect to Total Volume of Electrode Composite Material)

After the preparation of the positive electrode for a lithium-ion secondary battery, the dry weight (weight per unit area) of the electrode composite material layer was measured beforehand, and the mixture density of the electrode was determined based on the electrode thickness after pressing.

The volume occupied by each component in the electrode composite material was determined based on the weight ratio and true specific gravity (g/cm³) of each component constituting the electrode, and the volume filling factor of the electrode active material with respect to the total of the components was calculated.

Incidentally, the true specific gravity of the positive electrode active used in the present Example material was 4.73 g/cm³.

### [Preparation of Negative Electrode]

Sodium carboxymethylcellulose (CMC) as a binder and acetylene black as a conductivity aid were mixed, and dispersed using a planetary mixer, to obtain a mixture.

Artificial graphite (AG, D50=12 μm) as a negative electrode active material was mixed with the mixture obtained above, and dispersion treatment was performed again using the planetary mixer, to obtain a mixture for a negative electrode composite material.

Subsequently, the obtained mixture for a negative electrode composite material was dispersed in N-methyl-2-pyrrolidone (NMP), styrene butadiene rubber (SBR) as a binder was added thereto, to thereby prepare a negative electrode composite material paste such that the negative electrode active material:conductivity aid:styrene butadiene rubber (SBR):binder (CMC) of 96.5:1:1.5:1 in mass ratio was achieved.

A copper foil having a thickness of 12 μm was provided as a current collector, and the negative electrode composite material paste prepared above was applied to one side of the current collector, dried at 100° C. for 10 min, then compressed with a roll press at a linear pressure of 1 t/cm, and subsequently dried in vacuo at 120° C., to prepare a negative electrode for a lithium-ion secondary battery. Incidentally, the negative electrode prepared thus was punched into 34 mm×44 mm pieces and then used.

For the obtained negative electrode for a lithium-ion secondary battery, the thickness of the electrode composite material layer was determined according to the same method as the method for the positive electrode described above.

The result was 77 μm.

### [Preparation of Lithium-Ion Secondary Battery]

A nonwoven fabric of a three-layered polypropylene/polyethylene/polypropylene laminate as a separator (thickness 20 μm) was provided.

The positive electrode prepared above, the separator and the negative electrode prepared above were laminated and inserted into a bag prepared by heat-sealing and processing an aluminum laminate for a secondary battery (from Dai Nippon Printing Co., Ltd.) into a bag shape.

A solution prepared by dissolving LiPF₆ in a mixed solvent of ethylene carbonate, diethyl carbonate, ethyl methyl carbonate in a volume ratio of 30:30:40 so as to achieve 1.0 mol/L was used as an electrolyte solution, to prepare a lithium-ion secondary battery.

For the electrode of the obtained lithium-ion secondary battery, the occupancy of the cross-sectional area of the high dielectric oxide solid with respect to the cross-sectional area of the entire gap was determined according to the following method. The result was 11.6%.

(Determination Method for Occupancy of Cross-Sectional Area of High Dielectric Oxide Solid with Respect to Cross-Sectional Area of Entire Gap)

(1) The mixture layer of the positive electrode or the negative electrode was subjected to machining using an ion milling apparatus to expose the cross-section of the electrode, and thereby a cross-section sample of the electrode composite material layer was prepared.

(2) Imaging was performed using a field emission scanning electron microscopy (FE-SEM) under the conditions of an acceleration voltage of 3 kV, a magnification of images of 5,000× to 10,000×, and an image size of 1280×960.

The state of element distribution of the cross-section sample was identified by a reflected electron image and EDX.

(3) Binarization treatment of the reflected electron image of the cross-section sample was performed, and a graph of the brightness distribution curve was created. The obtained curve was differentiated to find the inflection point, and the area was divided into an electrode active material particles area, a high dielectric oxide solid particles area, and other area.

(4) The cross-sectional area occupancy of the electrode active material particles area, the cross-sectional area occupancy of the high dielectric oxide solid particles area, and the cross-sectional area occupancy of the other area (remaining space) were derived according to the division conditions set above.

(5) The operations (1) to (4) was performed for a total of eight points, three in the vertical direction and five in the left-right direction of the cross-sectional sample, and the average value of the cross-sectional area occupancy of the high dielectric oxide solid particles area for the points was designated as the occupancy of the cross-sectional area of the high dielectric oxide solid with respect to the cross-sectional area of the entire gap.

In calculating the cross-sectional area occupancy, the cross-sectional area occupancy A of the electrode active material particles area, the cross-sectional area occupancy B of the high dielectric oxide solid particles area, and the cross-sectional area occupancy C of the other area, i.e., the remaining space were determined.

The occupancy of the cross-sectional area of the high dielectric oxide solid with respect to the cross-sectional area of the entire gap was determined as the percentage (%) of the cross-sectional area occupancy B of the high dielectric solid oxide with respect to the sum of the cross-sectional area occupancy B of the high dielectric oxide solid particles area and the cross-sectional area occupancy C of the remaining space, i.e., (B/(B+C)×100).

### Examples 2 to 4

A lithium-ion secondary battery was prepared in the same manner as in Example 1, except that the lithium salt concentration of the electrolyte solution located the gap formed between the particles of the positive electrode active material in the positive electrode was changed as shown in Table 1.

### Comparative Examples 1 to 4

A lithium-ion secondary battery was prepared in the same manner as in Example 1, except that LATP, a solid oxide electrolyte, was not added to the positive electrode, and additionally the lithium salt concentration of the electrolyte solution located in the gap formed between the particles of the positive electrode active material was changed as shown in Table 1.

### Example 5

### [Preparation of Positive Electrode]

A positive electrode for a lithium-ion secondary battery was prepared in the same manner as in Example 1, except that LATP, a solid oxide electrolyte, was not added to the positive electrode.

### [Preparation of Negative Electrode]

Artificial graphite (AG, D50=12 μm) as a negative electrode active material, Li₇La₃Zr₂O₁₂ (LLZO, D50=0.5 μm) as a ferroelectric member as a lithium-ion-conductive solid electrolyte, and acetylene black as a conductivity aid were mixed, and dispersed using a planetary centrifugal mixer, to obtain a mixture.

Subsequently, the obtained mixture was dispersed in distilled water, then carboxymethylcellulose (CMC) and styrene butadiene rubber (SBR) as a binder were added, and dispersion treatment was performed using a planetary mixer, to obtain a negative electrode composite material paste.

Incidentally, the ratio of each component in the negative electrode composite material was adjusted to achieve the negative electrode active material:LLZO:conductivity aid:SBR:CMC of 94.5:2:1:1.5:1 in mass ratio, in other words, adjusted such that the amount of LLZO added was 2 parts by mass with respect to 100 parts by mass of the mixture for a negative electrode composite material.

A negative electrode for a lithium-ion secondary battery was prepared in the same manner as in Example 1 using the obtained negative electrode composite material paste, and punched into 34 mm 44 mm pieces.

The thickness of the obtained negative electrode for a lithium-ion secondary battery was 77 μm.

In addition, the volume filling factor of the electrode active material with respect to the total volume of the electrode composite material was 64.2%.

### [Preparation of Lithium-Ion Secondary Battery]

A lithium-ion secondary battery was prepared in the same manner as in Example 1 except the use of an electrolyte solution prepared by dissolving LiPF₆ so as to achieve 2.0 mol/L.

### <Evaluations>

The following evaluations were made on the lithium-ion secondary batteries obtained in Examples and Comparative Examples.

### [Initial Discharge Capacity]

The lithium-ion secondary battery prepared above was left to stand at a measurement temperature (25° C.) for 1 h, then was subjected to constant current charging at 0.33 C to 4.2 V and subsequently to constant voltage charging at a voltage of 4.2 V for 1 h, then was left to stand for 0.30 min. Then, discharge was permitted at a discharge rate of 0.2 C to 2.5 V, and initial discharge capacity was measured.

The results are shown in Tables 1 and 2.

### [Initial Cell Resistance]

The lithium-ion secondary battery after the measurement of the initial discharge capacity was adjusted to the state of charge (SOC) of 50%.

Next, the lithium-ion secondary battery was subjected to pulse discharge at a C rate of 0.2 C for 10 sec, and the voltage at the time of the completion of the 10 sec discharging was measured.

Then, the voltage at the time of the completion of the 10 sec discharging was plotted with respect to the current at 0.2 C, with the horizontal axis being the current value, and the vertical axis being the voltage.

Next, after being left to stand for 5 min, the lithium-ion secondary battery was subjected to auxiliary charging to reset the SOC to 50%, and further left to stand for 5 min.

Next, the operation described above was carried out at C rates of 0.5 C, 1 C, 2 C, 5 C, and 10 C, and the voltage at the time of the completion of the 10 sec discharging was plotted with respect to the current for each C rate.

Then, the slope of the approximation straight line obtained from each plot was designated as the internal resistance of the lithium-ion secondary battery obtained in the present Example.

The results are shown in Tables 1 and 2.

[Discharge Capacity after Durability Test]

As a charge-discharge cycle durability test, one cycle was defined as an operation of constant current charging at 1 C to 4.2 V, and subsequent constant current discharging at a discharge rate of 2 C to 2.5 V in a thermostated bath at 45° C., and this operation was repeated 500 times.

After the completion of the 500 cycles, the thermostated bath was set to 25° C., and the lithium-ion secondary battery was left to stand for 24 h as it was after the 2.5 V discharging, and subsequently, the discharge capacity after the durability test was measured in the same manner as the measurement of the initial discharge capacity.

The results are shown in Tables 1 and 2.

[Cell Resistance after Durability Test]

The lithium-ion secondary battery after the measurement of the discharge capacity after the durability test was adjusted by charging so as to have a state of charge (SOC) of 50% in the same manner as in the measurement of the initial cell resistance, and the cell resistance after the durability test was measured in accordance with the same method as the measurement of the initial cell resistance.

The results are shown in Tables 1 and 2.

### [Rate of Increase of Cell Resistance]

The cell resistance after the durability test with respect to the initial cell resistance was determined, and this was designated as a rate of increase of cell resistance.

The results are shown in Tables 1 and 2.

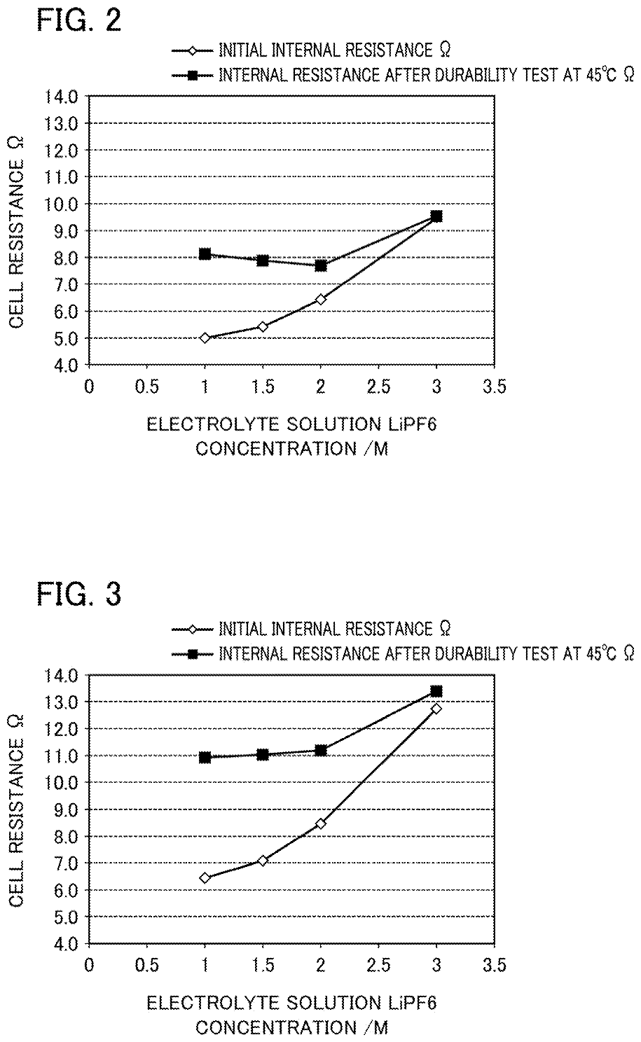

The relationship between the lithium salt concentration and the resistance value for the lithium-ion batteries obtained in Examples 1 to 4 is shown in FIG. 2.

In addition, the relationship between the lithium salt concentration and the resistance value for the lithium-ion batteries obtained Comparative Examples 1 to 4 is shown in FIG. 3.

### [Capacity Maintenance Rate]

The discharge capacity after the durability test with respect to the initial discharge capacity was determined, and this was designated as a capacity maintenance rate.

The results are shown in Tables 1 and 2.

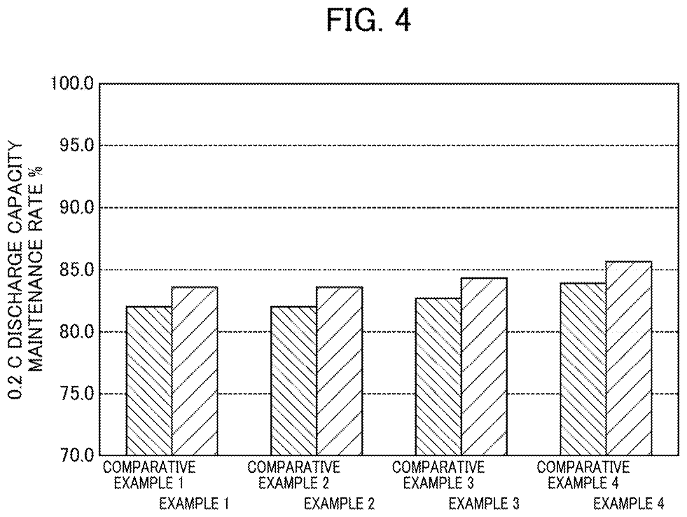

In addition, the capacity maintenance rates of the lithium-ion batteries obtained in Examples 1 to 4 and Comparative Examples 1 to 4 are shown in FIG. 4.

TABLE 1

| | | | | | Example |
|---|---|---|---|---|---|
| | | | | | 3 |
| | Example | Example | Example | Example | (Negative |
| | 1 | 2 | 3 | 4 | electrode |
| Solid oxide | 2.0 | 2.0 | 2.0 | 2.0 | 2.0 |
| electrolyte | | | | | |
| (% by mass) | | | | | |
| Lithium salt | 1.0 | 1.5 | 2.0 | 3.0 | 2.0 |
| concentration | | | | | |
| (mol/L) | | | | | |
| Cross- | 11.6 | 11.6 | 11.6 | 11.6 | 5.1 |
| Sectional | | | | | |
| Area | | | | | |
| Occupancy | | | | | |
| of High | | | | | |
| Dielectric | | | | | |
| Oxide | | | | | |
| Solid in Gap | | | | | |
| (%) | | | | | |
| Volume | 65.9 | 65.9 | 65.9 | 63.9 | 67.2 |
| filling | | | | | |
| factor of | | | | | |
| positive | | | | | |
| electrode | | | | | |
| active | | | | | |
| material (%) | | | | | |
| Volume | 65.5 | 65.5 | 65.5 | 65.5 | 64.2 |
| filling | | | | | |
| factor of | | | | | |
| negative | | | | | |
| electrode | | | | | |
| active | | | | | |
| material (%) | | | | | |
| Thickness of | 68 | 68 | 68 | 68 | 68 |
| positive | | | | | |
| electrode | | | | | |
| (μm) | | | | | |
| Thickness of | 77 | 77 | 77 | 77 | 77 |
| negative | | | | | |
| electrode | | | | | |
| (μm) | | | | | |
| Inital cell | 0.75 | 0.80 | 0.93 | 1.41 | 0.93 |
| resistance | | | | | |
| (Ω) | | | | | |
| Cell resistance | 1.23 | 1.18 | 1.12 | 1.44 | 1.12 |
| after | | | | | |
| durability | | | | | |
| test (Ω) | | | | | |
| Rate of | 164.1 | 147.1 | 120.8 | 102.1 | 119.6 |
| increase | | | | | |
| of cell | | | | | |
| resistance (%) | | | | | |
| Initial | 42.0 | 42.0 | 41.8 | 41.7 | 43.1 |
| discharge | | | | | |
| capacity | | | | | |
| (mAh) | | | | | |
| Discharge | 34.2 | 34.2 | 34.4 | 33.7 | 34.8 |
| capacity after | | | | | |
| durability test | | | | | |
| (mAh) | | | | | |
| Capacity | 81.4 | 81.4 | 82.4 | 80.9 | 80.8 |
| maintenance | | | | | |
| rate (%) | | | | | |

TABLE 2

| | Comparative | Comparative | Comparative | Comparative |
|---|---|---|---|---|
| | Example 1 | Example 2 | Example 3 | Example 4 |
| Solid oxide | — | — | — | — |
| electrolyte | | | | |
| (% by mass) | | | | |
| Lithium salt | 1.0 | 1.5 | 2.0 | 3.0 |
| concentration | | | | |
| (mol/L) | | | | |
| Cross- | 0.0 | 0.0 | 0.0 | 0.0 |
| Sectional | | | | |
| Area | | | | |
| Occupancy | | | | |
| of High | | | | |
| Dielectric | | | | |
| Oxide | | | | |
| Solid in Gap | | | | |
| (%) | | | | |
| Volume | 67.2 | 67.2 | 67.2 | 67.2 |
| filling | | | | |
| factor of | | | | |
| positive | | | | |
| electrode | | | | |
| active | | | | |
| material (%) | | | | |
| Volume | 65.5 | 65.5 | 65.5 | 65.5 |
| filling | | | | |
| factor of | | | | |
| negative | | | | |
| electrode | | | | |
| active | | | | |
| material (%) | | | | |
| Thickness of | 68 | 68 | 68 | 68 |
| positive | | | | |
| electrode | | | | |
| (μm) | | | | |
| Thickness of | 77 | 77 | 77 | 77 |
| negative | | | | |
| electrode | | | | |
| (μm) | | | | |
| Inital cell | 0.90 | 0.99 | 1.15 | 1.79 |
| resistance | | | | |
| (Ω) | | | | |
| Cell resistance | 1.54 | 1.54 | 1.52 | 1.88 |
| after | | | | |
| durability | | | | |
| test (Ω) | | | | |
| Rate of | 170.1 | 156.6 | 132.4 | 105.0 |
| increase | | | | |
| of cell | | | | |
| resistance (%) | | | | |
| Initial | 43.3 | 43.3 | 43.1 | 43.0 |
| discharge | | | | |
| capacity | | | | |
| (mAh) | | | | |
| Discharge | 34.2 | 34.2 | 34.4 | 33.7 |
| capacity after | | | | |
| durability test | | | | |
| (mAh) | | | | |
| Capacity | 79.0 | 79.0 | 80.0 | 78.5 |
| maintenance | | | | |
| rate (%) | | | | |

### EXPLANATION OF REFERENCE NUMERALS

lithium-ion secondary battery
1 container
2 positive electrode current collector
3 positive electrode composite material layer
4 positive electrode
5 negative electrode current collector
6 negative electrode composite material layer
7 negative electrode
8 separator
9 electrolyte solution

1. An electrode for a lithium-ion secondary battery comprising an electrode active material, a high dielectric oxide solid, and an electrolyte solution,
wherein the high dielectric oxide solid and the electrolyte solution are located in a gap formed between particles of the electrode active material, and
wherein a concentration of a lithium salt in the electrolyte solution is 0.5 to 3.0 mol/L.

2. The electrode for a lithium-ion secondary battery according to claim 1, wherein in cross-section observation of the electrode for a lithium-ion secondary battery, a proportion of a cross-sectional area of the high dielectric oxide solid with respect to a cross-sectional area of an entire gap is 1 to 22%.

3. The electrode for a lithium-ion secondary battery according to claim 1, wherein the high dielectric oxide solid is a solid oxide electrolyte.

4. The electrode for a lithium-ion secondary battery according to claim 3, wherein the solid oxide electrolyte is at least one selected from the group consisting of Li₇La₃Zr₂O₁₂ (LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7}(PO₄)₃ (LATP), and L_{1.6}Al_{0.6}Ge_{1.4}(PO₄)₃ (LAGP).

5. The electrode for a lithium-ion secondary battery according to claim 1, wherein a volume filling factor of the electrode active material is 60% or more with respect to a total volume of an electrode composite material constituting the electrode.

6. The electrode for a lithium-ion secondary battery according to claim 1, wherein a thickness of the electrode for a lithium-ion secondary battery is 40 μm or more.

7. The electrode for a lithium-ion secondary battery according to claim 1, wherein the electrode for a lithium-ion secondary battery is a positive electrode.

8. The electrode for a lithium-ion secondary battery according to claim 1, wherein the electrode for a lithium-ion secondary battery is a negative electrode.

9. A lithium-ion secondary battery comprising the electrode for a lithium-ion secondary battery according to claim 1, and an electrolyte solution.
